(19) United States
(12) Patent Application Publication
(10) Pub. No.: US 2008/0310020 A1
(43) Pub. Date: Dec. 18, 2008

(54) Polarizing plate

(75) Inventors: Yumiko Hashimoto, Osaka (JP); Atsushi Kanazawa, Osaka (JP); Takashi Fujii, Osaka (JP); Hakaru Miyakita, Kawabe-gun (JP)

Correspondence Address: BIRCH STEWART KOLASCH & BIRCH, PO BOX 747, FALLS CHURCH, VA, 22040-0747, US

(73) Assignee: SUMITOMO CHEMICAL COMPANY, LIMITED, Tokyo (JP)

(21) Appl. No.: 12/155,255

(22) Filed: May 30, 2008

(30) Foreign Application Priority Data
May 31, 2007 (JP) 2007-144636

(51) Int. Cl. G02B 5/30; B29D 11/00

(52) U.S. Cl. 359/485; 264/1.31

(57) ABSTRACT

A polarizing plate comprises at least two transparent substrates spaced apart and facing one another, and at least two polarizers provided between an outermost-positioned first transparent substrate and another outermost-positioned second transparent substrate, such that all the polarizers are sealed so as not to be in contact with outer air.

### BACKGROUND OF THE INVENTION

1. Field of the Invention

The present invention relates to a polarizing plate suitable for use in a projection-type liquid crystal display device such as a front projector, a rear projector or the like.

2. Related Background Art

In the trend towards ever larger screen sizes, projection-type liquid crystal display devices are rapidly gaining popularity both for business and domestic use, as an alternative to conventional CTR display devices. Projection-type display denotes herein a scheme whereby light from a light source is separated into the three primary colors RGB, so that light beams of the respective color pass via liquid crystal panels, polarizing plates and so forth along respective optical paths. The various light beams, which are expanded by a projection lens in a final stage, form then an image on a screen. As projection-type liquid crystal display devices, front projectors, in which the image is projected on the front side of the screen, as seen by a viewer, are used mainly in business, while rear projectors, in which the image is projected onto the rear side of the screen, are mainly for domestic use.

As a result of the recent trend towards higher screen brightness, projection-type liquid crystal display devices have come to employ light sources in the form of high-pressure mercury lamps, which emit a powerful light. For this reason, polarizing plates disposed in the optical paths must possess initial light resistance, whereby light leakage is unlikely to occur even when such a powerful light passes through the polarizing plates, over long periods of time, and also long-term light resistance, whereby light leakage does not occur even after prolonged storage under high humidity (hereinafter, both kinds of light resistance are referred to collectively as “light resistance”). Polarizing plate light resistance has become thus a decisive factor governing the life of a projection-type liquid crystal display device.

It has recently been reported that in a polarizing plate where a polarizing film comprising a polarizer and a protective layer is bonded to a transparent substrate having high thermal conductivity, the light resistance of the polarizing plate can be enhanced by lowering the temperature of the polarizer. For instance, Japanese Patent Application Laid-open No. 2000-206507 proposes a polarizing plate in which a sapphire glass having high thermal conductivity is used in a transparent substrate, while Japanese Patent Application Laid-open No. 2002-55231 proposes a polarizing plate in which a YAG substrate having high thermal conductivity is used in a transparent substrate.

Also, Japanese Patent Application Laid-open No. H10-39138 proposes the feature of directly sandwiching a polarizer between two transparent substrates, without employing protective layers, in order to allow the heat generated in the polarizers to be conducted directly into the transparent substrates.

Further, Japanese Patent Application Laid-open No. H10-133196 proposes a technology in which at least one among an incidence-side polarizing plate and an exit-side polarizing plate comprises plural partial polarizing plates acting overall as a single polarizing plate, sharing out thereby light absorption among the polarizing plates and reducing thus the thermal load thereof.

### SUMMARY OF THE INVENTION

Increased light intensity is required in light sources of present projection-type liquid crystal display devices. Under such circumstances, the light resistance of the polarizing plates needs to be further enhanced. Therefore, it is an object of the present invention to provide a polarizing plate that has sufficiently excellent light resistance and can miniaturize for small optical systems in projection-type liquid crystal display devices such as front projectors or rear projectors, to provide an optical member and a projection-type liquid crystal display device comprising the polarizing plate, and to provide a method for manufacturing the polarizing plate.

With a view to attaining that goal, the inventors perfected the present invention as a result of diligent research on the features of polarizing plates.

The present invention provides a polarizing plate comprising at least two transparent substrates spaced apart and facing one another, and at least two polarizers provided between an outermost-positioned first transparent substrate and another outermost-positioned second transparent substrate, wherein all the polarizers are sealed so as not to be in contact with outer air. Such a polarizing plate is sufficiently excellent in light resistance and can miniaturize for small optical systems in projection-type liquid crystal display devices such as front projectors or rear projectors.

In the polarizing plate, preferably, adhesive layers are respectively formed on mutually opposing inner faces of the first transparent substrate and the second transparent substrate, the polarizers being respectively attached to the transparent substrates via the adhesive layers.

In the polarizing plate of the present invention, preferably, the transmittance in the absorption axis direction of one of the polarizers respectively attached to the first transparent substrate and the second transparent substrate is 10% to 70%, while the transmittance in the absorption axis direction of the other polarizer is not greater than 1%, for light having a central wavelength of 440 nm, 550 nm or 610 nm. Deterioration of the polarizing plate can be curbed when the transmittance of the polarizers satisfies the above ranges.

In the polarizing plate, preferably, the face of the polarizer attached to the first transparent substrate, opposite the face at which the polarizer is in contact with the adhesive layer, and the face of the polarizer attached to the second transparent substrate, opposite the face at which the polarizer is in contact with the adhesive layer, are bonded via an adhesive layer.

Preferably, respective protective layers are formed on the faces of the polarizers respectively attached to the first transparent substrate and the second transparent substrate opposite the faces in contact with the adhesive layers. This allows increasing the mechanical strength to the polarizers.

Preferably, the protective layer formed on the polarizer attached to the first transparent substrate, and the protective layer formed on the polarizer attached to the second transparent substrate, are bonded via an adhesive layer.

In the polarizing plate of the present invention, preferably, the protective layer formed on the polarizer attached to the first transparent substrate, and the protective layer formed on the polarizer attached to the second transparent substrate, are bonded via adhesive layers sandwiching a third transparent substrate.

Light resistance can be further enhanced when the protective layers comprise a cured curable resin, and the thickness thereof is 0.1 μm to 30 μm.

Also, light resistance can be further enhanced when the main constituent of the protective layers is triacetyl cellulose or an olefin resin, and the thickness thereof is 5 μm to 50 μm.

Preferably, exposed portions not in contact with the adhesive layers and/or the protective layers, of the polarizers respectively attached to the first transparent substrate and the second transparent substrate, are sealed by a sealing agent. This allows preventing atmospheric moisture from penetrating into the polarizers, while further enhancing the light resistance of the polarizing plate.

In terms of further enhancing the light resistance of the polarizing plate, the sealing agent is preferably a resin having a water vapor permeability not greater than 60 g/m²·24 hr. Also, the sealing agent has preferably a boiling water absorption ratio not greater than 4 wt %.

In the polarizing plate of the present invention, the sealing agent may be the same material as the adhesive layers or the protective layers, whereby the periphery of the polarizers can be covered with the same material as the adhesive layers or the protective layers.

In terms of further enhancing the light resistance of the polarizing plate, at least one among the first transparent substrate and the second transparent substrate has preferably a thermal conductivity not lower than 5 W/(m·K).

Furthermore, in terms of achieving good contrast on the screen onto which images are projected by a projector, at least one among the first transparent substrate and the second transparent substrate has preferably a front retardation smaller than 5 nm in the 380 nm to 780 nm wavelength range.

The light resistance of the polarizing plate can be greatly enhanced when the water content of the polarizers is not greater than 5 wt %.

The present invention provides also an optical member comprising the polarizing plate and a retardation film bonded thereto. Such an optical member comprises the polarizing plate of the present invention, and is hence sufficiently excellent in light resistance.

The present invention provides also a polarizing plate manufacturing method, comprising the step of disposing at least two transparent substrates spaced apart and facing one another, forming respective adhesive layers on mutually opposing inner faces of an outermost-positioned first transparent substrate and another outermost-positioned second transparent substrate, and attaching respective polarizers onto the first transparent substrate and the second transparent substrate via the adhesive layers, wherein bonding of the transparent substrates and the polarizers via the adhesive layers is carried out under reduced pressure. A polarizing plate having sufficiently excellent light resistance can be manufactured as a result.

Preferably, the polarizing plate manufacturing method further comprises the step of drying the polarizers bonded to the transparent substrates at a temperature not higher than 130° C. This allows arbitrarily adjusting the water content of the polarizers.

The present invention provides also a projection-type liquid crystal display device comprising the polarizing plate.

The present invention allows thus providing a polarizing plate that has sufficiently excellent light resistance and can miniaturize for small optical systems in projection-type liquid crystal display devices such as front projectors or rear projectors, an optical member and a projection-type liquid crystal display device comprising the polarizing plate, and a method for manufacturing the polarizing plate.

### BRIEF DESCRIPTION OF THE DRAWINGS

FIG. 1 is a diagram for explaining an example of the constitution of a polarizing plate of the present invention (schematic diagram of Example 1);

FIG. 2 is a diagram for explaining an example of the constitution of a polarizing plate of the present invention (schematic diagram of Examples 6 to 10);

FIG. 3 is a diagram for explaining an example of the constitution of a polarizing plate of the present invention (schematic diagram of Example 3);

FIG. 4 is a diagram for explaining an example of the constitution of a polarizing plate of the present invention (schematic diagram of Example 2);

FIG. 5 is a diagram for explaining an example of the constitution of a polarizing plate of the present invention (schematic diagram of Example 4);

FIG. 6 is a diagram for explaining an example of the constitution of a polarizing plate of the present invention (schematic diagram of Example 5);

FIG. 7 is a diagram for explaining an example of the constitution of an optical member of the present invention;

FIG. 8 is a diagram for explaining the constitution of the polarizing plate used in Comparative example 1 (schematic diagram of Comparative example 1);

FIG. 9 is a diagram for explaining the constitution of the polarizing plate used in Comparative example 2 (schematic diagram of Comparative example 2);

FIG. 10 is a projector optical path diagram; and

FIG. 11 is a schematic diagram illustrating an apparatus for light resistance evaluation.

### DESCRIPTION OF THE PREFERRED EMBODIMENTS

Preferred embodiments of the present invention are explained in detail next with reference to accompanying drawings. The present invention, however, is not meant to be limited in any way to or by these embodiments. In the drawings, identical elements are denoted with identical reference numerals, and recurrent explanations thereof are omitted. Unless otherwise stated, the positional relationship among the elements in, for instance, the vertical and horizontal directions, are based on the positional relationship depicted in the drawings. The dimensional ratios in the drawings are not limited to the ratios depicted therein.

The polarizing plate of the present invention is a polarizing plate comprising at least two transparent substrates spaced apart and facing one another, and at least two polarizers provided between an outermost-positioned first transparent substrate and another outermost-positioned second transparent substrate, wherein all the polarizers are sealed so as not to be in contact with outer air.

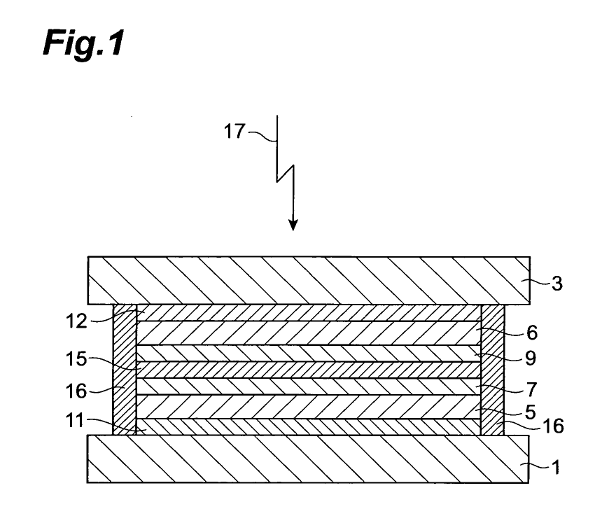

FIG. 1 is an overall diagram illustrating an embodiment of the polarizing plate according to the present invention. The polarizing plate in the figure comprises a transparent substrate 1, as a first transparent substrate, and a transparent substrate 3, as a second transparent substrate, spaced apart and facing one another, and having respectively formed, on the mutually opposing inner faces thereof, adhesive layers in the form of an adhesive layer 11 and an adhesive layer 12. Two polarizers 5, 6 are attached respectively to the transparent substrates 1, 3 via the adhesive layers 11, 12. Protective layers 7, 9 are respectively formed on the polarizers 5, 6, on the faces thereof opposite the faces in contact with the adhesive layers 11, 12. The protective layers 7, 9 are bonded via an adhesive layer 15.

The exposed portions of the polarizers 5, 6, where the adhesive layers 11, 12 and the protective layers 7, 9 do not come into contact with one another, are covered by a sealing agent 16 provided so as to prevent air moisture from penetrating into the polarizers 5, 6. The sealing agent 16 is formed on the outer peripheral region of the polarizers 5, 6. When the polarizers 5, 6 are shaped as squares, for instance, the sealing agent 16 is formed over all four sides of the polarizers 5, 6.

When the exposed portions of the polarizers 5, 6 are not sealed by the sealing agent 16, as in the below-described comparative examples, there is observed, for instance, a decrease in polarization degree and an increase in transmittance in the absorption axis direction in light resistance evaluation, which preclude maintaining a good light resistance. This is caused by moisture that penetrates into the polarizers through the end faces of the polyzers, exposed to outer air, exacerbating polarizer deterioration. The light resistance of the polarizing plate is dramatically improved by sealing the exposed portions of the polarizers 5, 6 with the sealing agent 16, which prevents as a result moisture in the atmosphere from penetrating into the polarizers 5, 6.

A known conventional sealing agent can be used as the sealing agent 16 of the present invention. Preferably, however, the sealing agent that is used has flowability during processing and has a sealing function through curing after processing. As the sealing agent there can be suitably used, for instance, a UV-curable resin, a thermosetting resin, or a resin that cures through both effects. The sealing agent may be of the same type as the below-described adhesives that form the adhesive layers. Specific sealing agents that can be used include polyolefin resins such as anhydride-modified ethylene copolymers (for instance “BYNEL” by DuPont), thermosetting adhesives such as epoxy resin-based adhesive agents (for instance, the thermosetting epoxy resin “EP582” by Cemedine Co., the UV-curable epoxy resin KR695A by Adeka Corp., the UV-curable epoxy resin “TB3025G” by Three Bond Co., Ltd., the UV-curable epoxy resin “XNR5516Z” by Nagase chemteX Corp.); urethane resin-based adhesives; phenolic resin-based adhesives or the like; silicone resins (for instance, UV-curable silicones, modified silicone resins comprising silyl-terminated polyethers); and UV-curable adhesives such as cyanoacrylates, acrylic resins or the like. As the sealing agent 16 there can also be used a film-like sealing agent such as a heat-shrinkable film imparted with a sealing function upon insertion, or a thermal adhesive film.

When using a UV-curable resin as the sealing agent 16, the volatile component before curing is preferably not greater than 2 wt %, and more preferably not greater than 1 wt %. A sealing agent having a volatile component not greater than 2 wt % has the effect of suppressing formation of small bubbles in the sealing agent after processing, while allowing applying the sealing agent under reduced pressure, all of which enhances processing yields considerably. The volatile content refers herein to the value measured in accordance with “JIS K 6249”.

Also, the glass transition temperature of the sealing agent 16 after curing is preferably not lower than 80° C., and the boiling water absorption ratio thereof is preferably not greater than 4 wt %. This enhances as a result thermal resistance and suppresses penetration of atmospheric moisture into the polarizers, thereby increasing the light resistance of the polarizing plate. The boiling water absorption ratio denotes the percentage of weight increase of a cured sealing agent after immersion for one hour in boiling water, as determined in accordance with “JIS K 6911”.

Ordinarily, the water vapor permeability of the sealing agent 16 is preferably not greater than 60 g/m²·24 hr, and more preferably, not greater than 25 g/m²·24 hr. A water vapor permeability of the sealing agent not greater than 60 g/m²·24 hr allows further suppressing penetration of atmospheric moisture into the polarizers, and allows also enhancing the light resistance of the polarizing plate. Herein, water vapor permeability denotes the amount of water that permeates through a cured product of the sealing agent prepared to a thickness of 100 μm, in an environment at a temperature of 40° C. and relative humidity of 90%, as determined in accordance with “JIS Z 0208”.

In terms of reducing air bubbles trapped in the sealing agent 16, the sealing agent is preferably infused under reduced pressure after bonding of the transparent substrates 1, 3 onto both faces of the polarizers 5, 6, as described below. The sealing agent 16 may also be injected simultaneously with the bonding of the transparent substrates 1, 3. In this case, the sealing agent 16 fulfills both a sealing function and a bonding function.

The material of the transparent substrates 1, 3 used in the present invention is, for instance, an inorganic transparent material. Specific examples thereof include silicate glass, borosilicate glass, titanium silicate glass, a fluoride glass such as zirconium fluoride, fused quartz, quartz crystal, sapphire, YAG crystal, fluorite, magnesia, spinel (MgO.Al₂O₃) or the like. Preferred materials among the foregoing are those having a thermal conductivity not lower than 5 W/(m·K), from the viewpoint of enhancing the light resistance of the polarizing plate by efficiently pumping out the heat generated in the polarizers 5, 6, reducing thereby the temperature of the polarizers 5, 6. Examples of such materials include, for instance, sapphire (thermal conductivity 40 W/(m·K)) and quartz crystal (thermal conductivity 8 W/(m·K)).

Preferably, at least one the transparent substrates 1, 3 has a front retardation smaller than 5 nm in the 380 nm to 780 nm wavelength range. When the front retardation of the transparent substrates is smaller than 5 nm, the light from a light source passes through the transparent substrates without warping of the polarized light plane caused by the passage of the light through the polarizers. This affords, as a result, good contrast on the screen onto which images are projected by the projector. Examples of such transparent substrates include silicate glass, borosilicate glass, titanium silicate glass, fused quartz (quartz glass), magnesia, and spinel.

Herein, “front retardation” is the value calculated according to (nₓ₁−n_{y1})×d₁, wherein nₓ₁, n_{y1}, and n_{z1} denote respective refractive indices in the axial directions of an X-axis, which is the direction in which the in-plane refractive index of the transparent substrate becomes maximum, a Y-axis, which is perpendicular to the X-axis, and a Z-axis in the thickness direction of the transparent substrate, and d₁ (mm) denotes the film thickness.

In terms of industrial yield and size matching with the projector optical system in which the polarizing plate is to be used, the thickness of the transparent substrates 1, 3 is preferably 0.05 mm to 3 mm, more preferably 0.08 mm to 2 mm. A thickness not smaller than 0.05 mm allows curbing breakage of the transparent substrate during processing, making thus for a stable manufacture, while a thickness of the transparent substrate not greater than 3 mm results in the obtained polarizing plate being small and lightweight.

The outer faces of the transparent substrates 1, 3 in contact with air are preferably subjected to an anti-reflection treatment according to the wavelength of the light used. Examples of anti-reflection treatments include, for instance, formation of a dielectric multilayer film by sputtering or vacuum vapor deposition, or coating with one or more low-refractive index layers. The antireflective surfaces may also be subjected to an antifouling treatment with a view to preventing dirt from adhering to the surfaces. Examples of antifouling treatments include forming, on the surface of interest, a thin film comprising such an amount of fluorine that has virtually no effect on antireflective performance.

The polarizers 5, 6 used in the present invention may be absorptive polarizers, reflective polarizers or scattering polarizers. Examples of absorptive polarizers include, for instance, polarizers comprising a polyvinyl alcohol (PVA) resin in which a film obtained by uniaxially stretching a PVA resin has adsorbed thereon a dichroic pigment such as iodine or a dichroic dye. Reflective polarizers include, for instance, wire grid polarizers having an array of fine metal wiring, photonic crystal polarizers comprising a laminate of dielectric thin films, or dielectric multilayer film polarizers. The foregoing may be formed directly on the transparent substrate, or may serve as polarizers formed on a transparent film. Examples of reflective polarizers include also, for instance, polarizers obtained by laminating films having retardation that satisfy specific conditions (for example, “DBEF” by 3M). Scattering polarizers include, for instance, polarizers obtained by orienting and dispersing, in a binder, liquid crystal molecules satisfying specific conditions.

The effect of the polarizing plate of the present invention is prominent when absorptive polarizers are used in the polarizing plate. Examples of absorptive polarizers include polarizers obtained by adsorbing and orienting iodine or a dichroic dye onto a polarizer substrate comprising a polyvinyl alcohol resin, a polyvinyl acetate resin, an ethylene-vinyl acetate (EVA) resin, a polyamide resin, a polyester resin or the like.

Polyvinyl alcohol resins used in the polarizer substrate include herein polyvinyl alcohol, which is a partially or completely saponified product of polyvinyl acetate; a saponification product, such as saponified EVA resin or the like, of a copolymer of vinyl acetate and other monomers copolymerizable therewith (for instance, an olefin such as ethylene or propylene, an unsaturated carboxylic acid such as crotonic acid, acrylic acid, methacrylic acid and maleic acid, an unsaturated sulfonic acid, or a vinyl ether); and polyvinyl formal, polyvinyl acetal or the like obtained by modifying polyvinyl alcohol with an aldehyde. From the viewpoint of dye adsorption and orientation properties, a film of a polyvinyl alcohol resin, in particular a film comprising polyvinyl alcohol, is preferably used as the polarizer substrate.

Polarizers comprising polyvinyl alcohol-polyvinylene copolymers are obtained from a polyvinyl alcohol film, having been imparted molecular orientation by stretching or the like, that is exposed to concentrated hydrochloric acid or concentrated sulfuric acid to elicit partial dehydration and generate thereby conjugated blocks of polyvinylene. The polarizers may comprise such copolymers, without further modification, although the polarizers used are ordinarily also impregnated with boric acid and/or borax.

In terms of light resistance, a dichroic dye is preferably adsorbed onto and oriented in the polarizer substrate. Polarizers for blue channel (Bch), green channel (Gch) and red channel (Rch) projection-type liquid crystal display devices are respectively manufactured by using dyes having different wavelength dependencies.

Dichroic dye compounds are disclosed in “Development of Dichroic Dyes for Liquid Crystal Displays” (Kayane et al., Sumitomo Chemical, 2002-II, pages 23 to 30). Specifically, examples of dichroic dyes are represented by formula (I) below, in the free acid form.

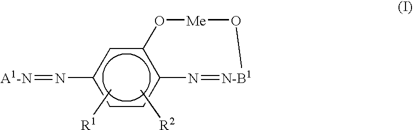

In formula (I), Me represents a metal atom selected from the group consisting of copper atoms, nickel atoms, zinc atoms and iron atoms. A¹ represents a substituted or unsubstituted phenyl group or a substituted or unsubstituted naphthyl group. B¹ represents a substituted or unsubstituted naphthyl group. The oxygen atom bonded to Me and the azo group represented by —N═N— are bonded to carbon atoms in mutually adjacent positions of the benzene ring. R¹ and R² represent each independently a C1 to C4 alkyl group, a C1 to C4 alkoxyl group, a carboxyl group, a sulfoxy group, a sulfonamido group, a sulfonalkylamido group, an amino group, an acylamino group, a nitro group or a halogen atom.

Further, examples of dichroic dyes are represented by formula (II) below, in the free acid form.

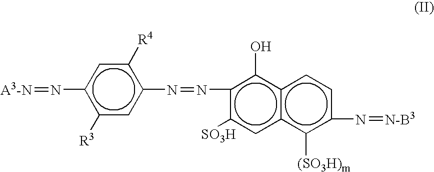

In formula (II), A³ and B³ represent each independently a substituted or unsubstituted phenyl group or a substituted or unsubstituted naphthyl group, R³ and R⁴ represent each independently hydrogen atom, a C1 to C4 alkyl group, a C1 to C4 alkoxyl group, a carboxyl group, a sulfoxy group, a sulfonamido group, a sulfonalkylamido group, an amino group, a halogen atom or a nitro group, and m is 0 or 1.

Further examples of dichroic dyes are represented by formula (III) below, in the free acid form.

Q¹-N═N-Q²-X-Q³-N═N-Q⁴ (III)

In formula (III), Q¹ and Q⁴ represent each independently a substituted or unsubstituted phenyl group or a substituted or unsubstituted naphthyl group, and Q² and Q³ represent each independently a substituted or unsubstituted phenylene group, and X represents a divalent group represented by formula (III-1) or formula (III-2) below.

—N═N— (III-1)

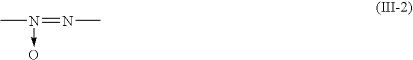

Other examples of dichroic dyes are represented by formula (IV) below, in the free acid form.

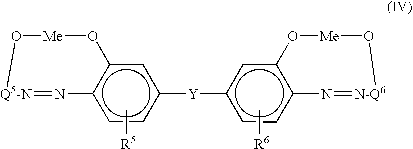

In formula (IV), Me represents a metal atom selected from the group consisting of copper atoms, nickel atoms, zinc atoms and iron atoms, Q⁵ and Q⁶ represent each independently a substituted or unsubstituted naphthyl group, the oxygen atom bonded to Me and the azo group represented by —N═N— are bonded to carbon atoms in mutually adjacent positions of the benzene ring, and R⁵ and R⁶ represent each independently a hydrogen atom, a C1 to C4 alkyl group, a C1 to C4 alkoxyl group or a sulfoxy group, and Y represents a divalent group represented by formula (IV-1) or formula (IV-2) below.

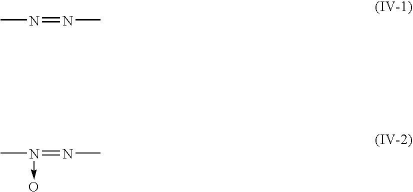

Examples of such dichroic dyes include dyes, denoted by their Color Index Generic Name, selected from the group consisting of C.I. Direct Yellow 12, C.I. Direct Red 31, C.I. Direct Red 28, C.I. Direct Yellow 44, C.I. Direct Yellow 28, C.I. Direct Orange 107, C.I. Direct Red 79, C.I. Direct Red 2, C.I. Direct Red 81, C.I. Direct Orange 26, C.I. Direct Orange 39, C.I. Direct Red 247 and C.I. Direct Yellow 142.

The dichroic dye may be used in the free acid form, or in the form of an amine salt such as an ammonium salt, an ethanolamine salt or an alkylamine salt. Ordinarily, the dichroic dye is preferably used in the form of an alkaline metal salt such as a lithium salt, a sodium salt a potassium salt or the like. The dichroic dye can be used singly or in combinations of two or more.

The polarizer is manufactured, for instance, as described next. Firstly there is prepared a dye bath by dissolving the dichroic dye in water, to a concentration of about 0.0001 to about 10 wt %. If necessary, a dyeing auxiliary agent may also be used. For instance, sodium sulfate dissolved to 0.1 to 10 wt % in the dye bath is preferably used as a dyeing auxiliary agent.

The substrates of the polarizer are dyed through dipping in the dye bath thus prepared. The dyeing temperature ranges preferably from 40 to 80° C. The dye is oriented by stretching the polarizing film substrate before dyeing or by stretching the dyed polarizer substrate. Stretching can be carried out, for instance, by wet stretching or dry stretching.

A post-treatment such as a boric acid treatment may also be carried out with a view to enhancing the light transmittance, degree of polarization and light resistance of the polarizer. Conditions in the boric acid treatment vary depending on the kind of polarizer substrate and the kind of dye used. Usually, however, the treatment is carried out by dipping the polarizing film substrate in an aqueous boric acid solution prepared to a concentration of from 1 to 15 wt %, preferably from 5 to 10 wt %, at a temperature of from 30 to 80° C., preferably from 50 to 80° C. If desired, the polarizing film substrate may further be subjected to a fixing treatment in an aqueous solution containing a cationic polymer compound.

In the polarizing plate illustrated in FIG. 1, the transmittance in the absorption axis direction of the polarizer 6 through which incident light 17 passes initially is preferably higher than the transmittance of a polarizer 5 through which the incident light 17 passes next. Specifically, the transmittance in the absorption axis direction of the polarizer 5, through which the light passes second, is preferably not greater than 1%, and the transmittance in the absorption axis direction of the polarizer 6, through which light passes first, ranges preferably from 10% to 70%, at the central wavelength of the light used. If the transmittance in the absorption axis direction of the polarizer 6 is smaller than 10%, the heat generated in the polarizer 6 increases, which may exacerbate the deterioration of the polarizer 6. On the other hand, if the transmittance in the absorption axis direction of the polarizer 6 is greater than 70%, the heat generated in the polarizer 5 may increase as a result. Setting the transmittance in the absorption axis direction of the polarizer 6 to range between 10% and 70% has the effect of averting thermal load imbalances in the polarizer 5 and the polarizer 6, and allows curbing the deterioration of the polarizing plate in which the polarizer 5 and the polarizer 6 are integrally laminated. The central wavelength of the used light varies depending on the RGB color thereof. The wavelength for measuring the absorption axis transmittance is 610 nm for Rch, 550 nm for Gch and 440 nm for Bch.

The water content of the polarizers 5, 6 used in the present invention is preferably not greater than 5 wt %, more preferably not greater than 1 wt %. In a polarizer manufactured by adding a dichroic dye to PVA, setting the water content to be not greater than 5 wt % results in a dramatic suppression of dye decomposition, which allows greatly enhancing the light resistance of the obtained polarizing plate.

The method for measuring the water content of the polarizers 5, 6 involves draught-drying of an exposed polarizer, at 130° C. for 20 minutes, and determining the ratio of weight reduction in the polarizer. Specifically, the water content is calculated using the formula below.

Water content (%)=[(W1−W2)/W1]×100,

wherein W1 is the weight of the polarizer before drying and W2 is the weight of the polarizer after drying.

The water content of the polarizers 5, 6 can be adjusted on the basis of polarizer drying. The drying operation for adjusting the water content of the polarizers 5, 6 to be not greater than 5 wt % may take place at a stage where none of the transparent substrates 1, 3 is bonded to any of the polarizers 5, 6, or at a stage where the transparent substrates 1, 3 are bonded to one face or both faces of the polarizers 5, 6. Drying at a stage where a transparent substrate is bonded to a single face is preferable since doing so allows preserving the flatness of the polarizer, while at the same time water can be eliminated speedily through the faces of the polarizers 5, 6 onto which the transparent substrates 1, 3 are not yet bonded. This is advantageous in that the dryness of the polarizers is easier to maintain thereby, without water intruding from the side of the transparent substrates after drying. Preferably, drying is carried out at the stage where the transparent substrates are bonded to one face of the polarizers 5, 6, and then the transparent substrates are bonded to the other face of the polarizers, followed by drying at a temperature not higher than 130° C. This affords a yet more thorough drying of the polarizers.

Any conventionally known drying method, such as heat drying or vacuum drying, may be used for drying. Heat drying is preferable in that it is done simple equipment in the manufacture of the polarizing plate. Examples of heat drying methods include, for instance, placement in a heating oven, or irradiation of light onto the polarizing plate to exploit the heat generated by the polarizing plate itself as it absorbs light from the polarizers. Regardless of the heating method, the heating temperature during heat drying is preferably not higher than 130° C., more preferably of 40° C. to 130° C., and yet more preferably of 50° C. to 100° C. Drying can be over within a relatively short time at a temperature of 40° C. or above, while degradation of the adhesive layers, protective layers, and/or deterioration of the optical characteristics of the polarizers can be curbed by setting the temperature not to exceed 130° C.

The material of the adhesive layers 11, 12, 15 of the polarizing plate of the present invention may be, for instance, a UV-curable adhesive, a thermosetting adhesive or the like. A UV-curable adhesive is preferred among the foregoing on account of its fast curing speed. The heat generated in the polarizers 5, 6 is dissipated mainly via the transparent substrates 1, 3, and hence the thickness of the adhesive layers 11, 12 is an important factor. Preferably, the thickness of the adhesive layers 11, 12 ranges from 0.1 μm to 15 μm, more preferably from 1 μm to 10 μm. Sufficient adhesive strength can be obtained when the thickness of the adhesive layers 11, 12 is 0.1 μm or greater. Meanwhile, a thickness not greater than 15 μm allows the heat generated in the polarizers 5, 6 to be transmitted to the transparent substrates 1, 3 with good efficiency, and allows enhancing the light resistance of the polarizing plate. Bonding of the polarizers 5, 6 with the transparent substrates 1, 3 via the adhesive layers 11, 12 is carried out preferably under reduced pressure, lower than atmospheric pressure, with a view to preventing bubbles from becoming trapped in the adhesive layers 11, 12.

The material of the protective layers 7, 9 of the polarizing plate of the present invention may be, for instance, a polyolefin-based adhesive such as an anhydride-modified ethylene copolymer (for instance BYNEL (registered trademark), by DuPont), a thermosetting adhesive such as an epoxy resin-based adhesive, an urethane resin-based adhesive, a phenolic resin-based adhesive or the like, a silicone resin (for instance, the UV-curable resin FX-V550 by Adeka Corp., a UV-curable silicone, silicone RTV, silicone rubber, or a modified silicone resins comprising silyl-terminated polyether), and UV curable adhesives such as cyanoacrylates, acrylic resins or the like. Preferred amongst these are solventless adhesives, as they allow preventing solvents from penetrating between the transparent substrates 1, 3 and the polarizers 5, 6.

For forming the protective layers 7, 9 on the polarizers 5, 6, film-like protective layers 7, 9 may be formed by being pasted onto the polarizers 5, 6. Alternatively, a UV-curable resin of the protective layers 7, 9 may be coated on the surfaces of the polarizers 5, 6, followed by curing, to form the protective layers 7, 9. Formation of the protective layers 7, 9 on the polarizers 5, 6 may take place at a step prior or subsequent to the bonding of the polarizers 5, 6 to the transparent substrates 1, 3. Forming the protective layers 7, 9 on the polarizers 5, 6 has the effect of enhancing the mechanical strength of the polarizers 5, 6 and improving manufacturing yield, and of allowing preventing the occurrence of cracking in the polarizers 5, 6 after prolonged use in a projection-type liquid crystal display device.

When the substrate of the polarizers 5, 6 comprises PVA and the protective layers 7, 9 are obtained through coating and curing of a curable resin, the curable resin is preferably a thermosetting resin and a UV-curable resin. In this case, a UV-curable resin is particularly preferable as it does not require a high temperature during the curing step, and does not impair the optical performance of the polarizing plate. The thickness of the protective layers 7, 9 ranges preferably from 0.1 μm to 30 μm, more preferably from 1 μm to 20 μm. A thickness of the protective layers 7, 9 of 0.1 μm or greater results in an increased mechanical strength of the polarizers 5, 6, which allows preventing damage to the polarizers 5, 6. A thickness of the protective layers 7, 9 not greater than 30 μm allows the heat generated in the polarizers 5, 6 on account of light absorption to be transmitted to the transparent substrates 1, 3 with good efficiency, enhancing as a result the light resistance of the polarizing plate.

When the substrate of the polarizers 5, 6 comprises PVA and the main constituent of the protective layers 7, 9 is triacetyl cellulose or an olefin resin, the thickness of the protective layers 7, 9 ranges preferably from 5 μm to 50 μm.

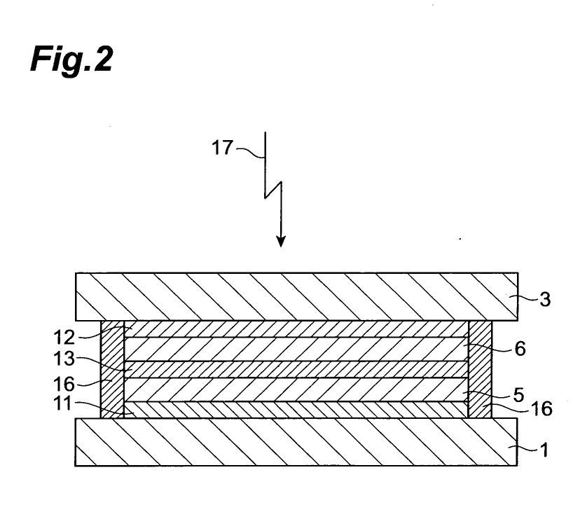

FIGS. 2 to 6 are schematic cross-sectional diagrams illustrating another embodiment of the polarizing plate according to the present invention. The polarizing plate illustrated in FIG. 2 differs from the polarizing plate of FIG. 1 in that now no protective layers 7, 9 are provided on polarizers 5, 6, so that the polarizers 5, 6 are bonded directly via an adhesive layer 13. Such a constitution results in a yet smaller polarizing plate and increased productivity.

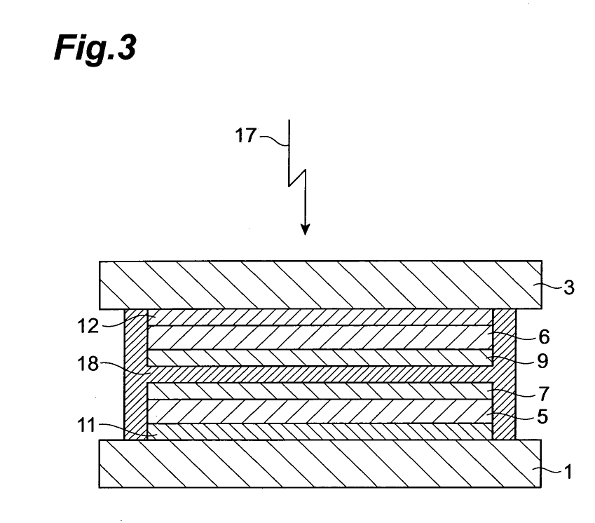

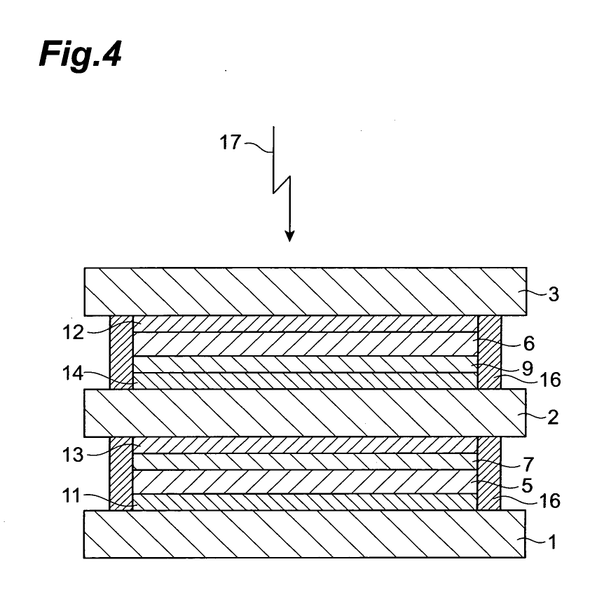

The polarizing plate illustrated in FIG. 3 differs from the polarizing plate of FIG. 1 in that the same material as that of the adhesive layer 15 in the polarizing plate of FIG. 1 is used now as the material of sealing agent 18. That is, an adhesive layer 18 that bonds the protective layer 7 and the protective layer 9 covers as well the periphery of the polarizers 5, 6, functioning thus also as a sealing agent. In the polarizing plate illustrated in FIG. 4, the polarizers 5, 6 are attached to the transparent substrates 1, 3 via adhesive layers 11, 12, and protective layers 7, 9 are further formed on the polarizers 5, 6. The protective layers 7, 9 are bonded via adhesive layers 13, 14 with a transparent substrate 2 sandwiched therebetween. The exposed portions of the polarizers 5, 6 are sealed by a sealing agent 16. In such a constitution, the heat generated in the polarizers 5, 6 is transmitted to the transparent substrate 2, in addition to the transparent substrates 1, 3, thereby further enhancing heat removal from the polarizers 5, 6.

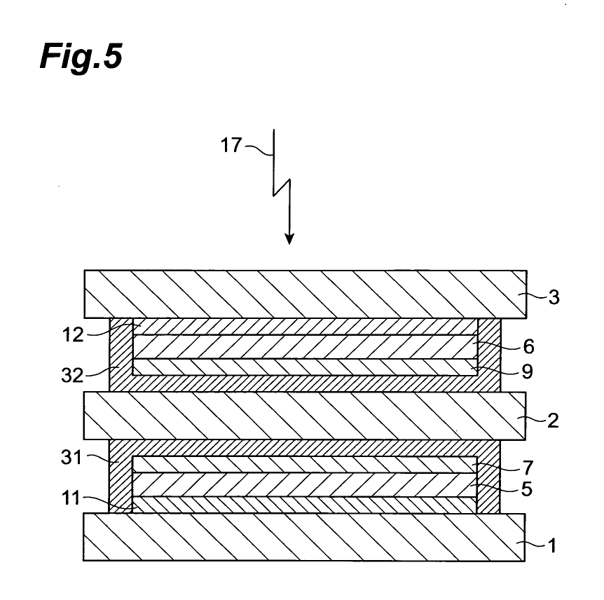

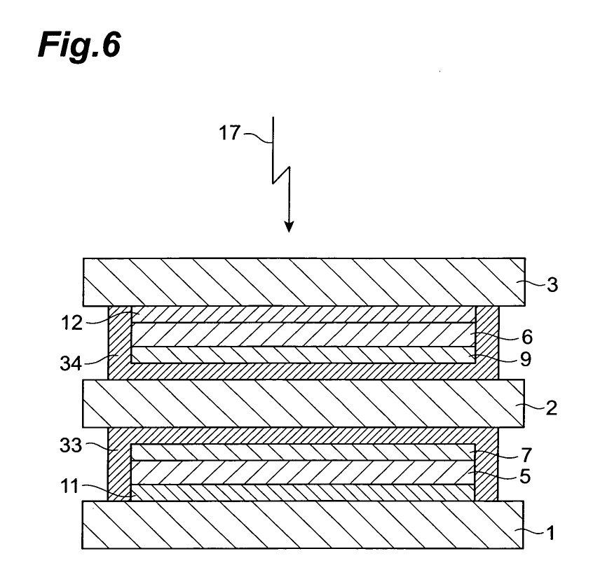

The polarizing plate illustrated in FIG. 5 differs from the polarizing plate of FIG. 4 in that the same material as that of the adhesive layers 13, 14 in the polarizing plate of FIG. 4 is used now as the material of sealing agents 31, 32. That is, the adhesive layers 13, 14 in the polarizing plate illustrated in FIG. 4 are made to cover as well the periphery of the polarizers 5, 6, functioning also as a sealing agent. In the polarizing plate illustrated in FIG. 6, the protective layers 7, 9 cover the periphery of the polarizers 5, 6, while the same material as that of the adhesive layers 13, 14 in the polarizing plate of FIG. 4 is used now as the material of sealing agents 33, 34, such that the exposed portions of the polarizers 5, 6 are sealed by the protective layers 7, 9 and the sealing agents 33, 34.

In the embodiments of the polarizing plate explained above there are used two polarizers. The number of polarizers in the present invention, however, is not limited, and the invention affords the same effect when using three or more polarizers. The same applies to the transparent substrates, where identical effects are achieved using four or more transparent substrates.

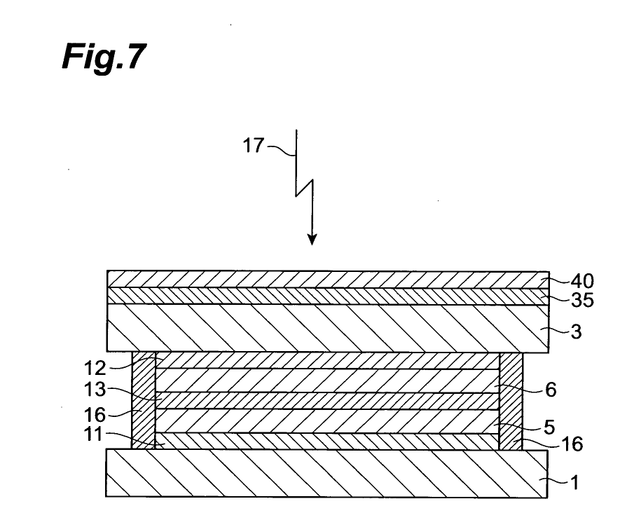

An optical member according to the present invention is explained next. The optical member of the present invention comprises the above-described polarizing plate, and a retardation film bonded thereto, the retardation film being bonded to the outer surface of the transparent substrate in the above-described polarizing plate. Specifically, the optical member of the present invention is obtained by bonding a retardation film bonded onto at least one of the outer faces of the first transparent substrate and the second transparent substrate of the polarizing plate of the present invention. FIG. 7 illustrates an example of the optical member of the present invention. The optical member of FIG. 7 comprises a retardation film 40 bonded to the surface of the transparent substrate 3 of the polarizing plate illustrated in FIG. 2 via an adhesive layer 35. Examples of the adhesive that forms the adhesive layer 35 include, for instance, elastic adhesives, self-adhesive agents and curable adhesives. Preferred amongst these are curable adhesives.

A known conventional retardation film can be used in the present invention, thus, as the retardation film 40 employed, which is not particularly limited. As the retardation film 40 there can be used, for instance, a film in which a discotic liquid crystal, imparted with oblique orientation or hybrid orientation, is held in a matrix comprising a cross-linked transparent organic polymer. As the matrix material of the retardation film there is preferably used an organic polymer film having excellent environment resistance and chemical resistance, for instance triacetyl cellulose, polycarbonate, polyethylene terephthalate or the like.

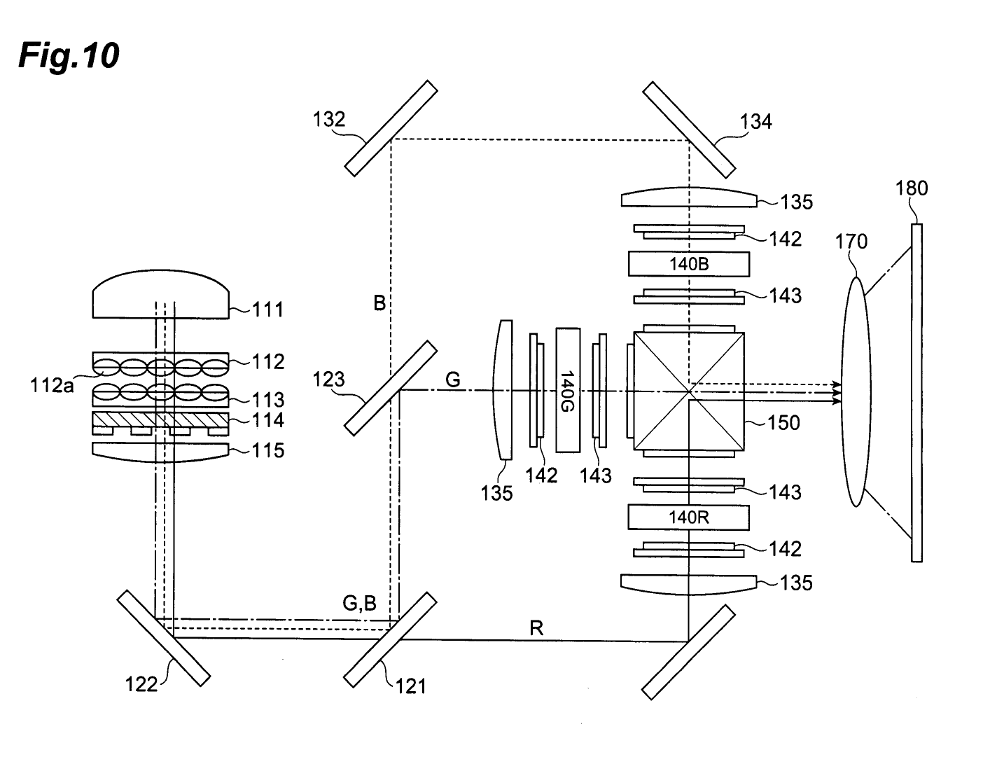

The polarizing plate of the present invention can be used, for instance, in projection-type liquid crystal display devices (projectors). Details thereof will be explained based on an example of the optical system of a rear projector illustrated in FIG. 10.

Light beams from a high-pressure mercury lamp 111 as a light source are firstly polarized and imparted homogeneous brightness, at the anti-beam cross section, by a first lens array 112, a second lens array 113, a polarization conversion element 114 and a superposition lens 115. Specifically, light beams emitted by the light source 111 are split into multiple small light beams by way of the first lens array 112 in which small lenses 112a are disposed as a matrix. The second lens array 113 and the superposition lens 115 are provided in such a manner that the split light beams are irradiated respectively over the entirety of three LCD panels 140R, 140G, 140B as irradiation targets. As a result, illuminance is substantially homogeneous over the entire incidence surfaces of the respective LCD panels.

The polarization conversion element 114, which comprises ordinarily a polarizing beam splitter array, is disposed between the second lens array 113 and the superposition lens 115. As a result, the polarization conversion element 114 converts beforehand random polarized light issuing from the light source into polarized light having a specific polarization direction, and reduces light intensity loss at the below-described incidence-side polarizing plates, thereby fulfilling the role of enhancing screen brightness.

The light thus polarized and imparted homogeneous brightness is reflected by a reflective mirror 122 and is sequentially separated into a red channel, a green channel and a blue channel by dichroic mirrors 121, 123, 132 for separating RGB into the three primary colors. The separated beams strike then the respective LCD panels 140R, 140G, 140B.

Polarizing plates 142 (incidence side) and polarizing plates 143 (exit side) are respectively arranged on the incidence sides and exit sides of the LCD panels 140R, 140G, 140B.

An explanation follows next on the two polarizing plates disposed at the incidence side and exit side of the liquid crystal panels, sandwiching the liquid crystal panels, at the respective RGB optical paths. The polarizing plates 142 (incidence side) and the polarizing plates 143 (exit side) are disposed at the respective optical paths in such a manner that light beams propagate along the absorption axes of the polarizing plates. Herein, the polarizing plates 142 (incidence side) and the polarizing plates 143 (exit side) fulfill the function of converting into light intensity the polarization state, controlled for each pixel on the basis of image signals, at the LCD panels 140R, 140G, 140B disposed in the respective optical paths.

The polarizing plate of the present invention shares a common constitution for all the optical paths in the blue channel, the green channel and the red channel. The polarizing plate of the present invention is effective as a polarizing plate having excellent durability, in all optical paths, but is particularly effective in the blue channel and the green channel.

The optical images formed by the transmitted incident light having dissimilar transmittance for each pixel, in accordance with the image data of the LCD panels 140R, 140G, 140B, are then combined by a cross dichroic prism 150, and are expanded and projected onto a screen 180 by way of a projection lens 170.

In the polarizing plates, the polarizers having small transmittance in the absorption axis direction are ordinarily disposed at the light source side rather than at the incidence side and exit side.

### EXAMPLES

The present invention is explained in further detail by way of the examples below. However, the present invention is in no way meant to be limited to or by the examples.

### Example 1

In Example 1 a polarizing plate having the constitution illustrated in FIG. 1 was manufactured as follows. Firstly, polarizers for projector blue channel were obtained first through uniaxial stretching of a polyvinyl alcohol film (“VF-PX” by Kuraray Co., Ltd, hereinafter “PVA film”), and by dying the film with a polyazo dye for blue absorption, followed by drying. The polarizer 5 had a polarization degree of 99.9%, and a transmittance in the absorption axis direction of 0.0% at 440 nm while the polarizer 6 had a polarization degree of 32.0%, and a transmittance in the absorption axis direction of 46.0% at 440 nm.

On one face of the polarizer 5 thus obtained there was bonded, under reduced pressure, a 0.5 mm-thick transparent substrate 1 (sapphire substrate, by Kyocera Corp.) via the adhesive layer 11 comprising an acrylic UV-curable adhesive (“MO5” by Adell Corp.) (thickness of the adhesion layer 5 μm). On the other face of the polarizer 5 there was coated and cured a silicone UV-curable resin (“FXV 550” by Adeka Corp.) to form the protective layer 7 having a thickness of 10 μm (the whole is referred to hereinafter as “intermediate constituent A”).

Similarly, on one face of the polarizer 6 there was bonded a 0.5 mm-thick transparent substrate 3 (quartz crystal substrate) via the adhesive layer 12 comprising an acrylic UV-curable adhesive (“MO5” by Adell Corp.), while on the other face there was formed the protective layer 9 having a thickness of 10 μm (the whole is referred to hereinafter as “intermediate constituent B”). The intermediate constituent A and the intermediate constituent B were both dried for 10 hours in an oven at 70° C., to adjust thereby the water content of the polarizers 5, 6 to be not greater than 5 wt %. The protective layer 7 of the intermediate constituent A and the protective layer 9 of the intermediate constituent B were bonded at reduced pressure using the adhesive layer 15 comprising an acrylic UV-curable adhesive (“MO5” by Adell Corp.). Thereafter, the exposed portions of the polarizers 5, 6 were sealed by applying the sealing agent 16, comprising a thermosetting epoxy resin (“EP582” by Cemedine Co., water vapor permeability 20 g/m²·24 hr), on the exposed portions around the polarizers 5, 6, followed by curing. An antireflection treatment comprising five dielectric layers formed by vacuum vapor deposition was applied to the outer faces, exposed to air, of the used sapphire substrate and quartz crystal substrate.

The polarizing plate thus manufactured, having the constitution illustrated in FIG. 1, had a thickness of about 1.1 mm, which is thinner than the thickness of the polarizing plates in the below-described comparative examples, being thus appropriate for small optical systems in projection-type liquid crystal display devices or the like.

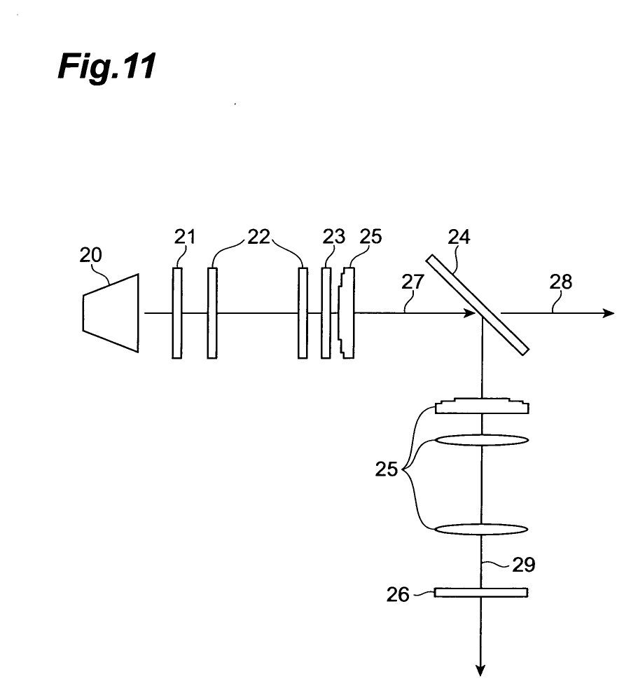

For evaluating the light resistance of the manufactured polarizing plate, the polarizing plate was interposed in the optical path for blue channel of the light resistance evaluation apparatus illustrated in FIG. 11, to investigate the occurrence of light leakage caused by polarizing plate deterioration (hereinafter, “initial evaluation”). Moreover, the light resistance of the obtained polarizing plate was evaluated in the same way after being left to stand for 72 hours in an environment at 60° C. and 90% relative humidity (hereinafter, “long-term evaluation”). The results are given in Table 1.

The light resistance evaluation apparatus of FIG. 11, which has an optical system identical to the optical system of a rear projection TV, comprises a 130 W high-pressure mercury lamp, by Philips, as a light source 20, a polarizing beam splitter array 23, lenticular lenses 25 and so forth. The irradiance on the polarizing plate 26 is 3.0 W per cm². Herein, light leakage denotes a phenomenon whereby the polarizing plate 26 deteriorates after placement in the light resistance evaluation apparatus, with an increase of the transmittance in the absorption axis direction thereof. When a polarizing plate to be evaluated and a normal polarizing plate are disposed in a cross-Nicol arrangement, this phenomenon becomes apparent in that transmitted leaked light comes from the polarizing plate originally having low transmittance. The light resistance of a Bch polarizing plate was evaluated in the present experiment, where the criterion for light leakage is “no light leakage if transmittance in the absorption axis direction is not greater than 0.3% at 440 nm”.

### Example 2

In Example 2 a polarizing plate having the constitution illustrated in FIG. 4 was manufactured as follows. As in Example 1, the intermediate constituent A and the intermediate constituent B were both dried for 10 hours in an oven at 70° C., to adjust thereby the water content of the polarizers 5, 6 to be not greater than 5 wt %. Thereafter, the protective layer 7 of the intermediate constituent A and the protective layer 9 of the intermediate constituent B were disposed sandwiching a 0.5 mm transparent substrate 2 (soda lime glass) in between, and were bonded at reduced pressure via adhesive layers 13, 14 comprising an acrylic UV-curable adhesive (“MO5” by Adell Corp.).

Thereafter, the exposed portions of the polarizers 5, 6 were sealed by applying the sealing agent 16, comprising a thermosetting epoxy resin (“EP582” by Cemedine Co., water vapor permeability 20 g/m²·24 hr), on the exposed portions around the polarizers 5, 6, followed by curing.

The polarizing plate thus manufactured, having the constitution illustrated in FIG. 4 had a thickness of about 1.1 mm, which is thinner than the thickness of the polarizing plates in the below-described comparative examples, being thus appropriate for small optical systems in projection-type liquid crystal display devices or the like. The light resistance of the manufactured polarizing plate, was evaluated as in Example 1. The results are given in Table 1.

### Example 3

In Example 3 a polarizing plate having the constitution illustrated in FIG. 3 was manufactured as follows. As in Example 1, the intermediate constituent A and the intermediate constituent B were both dried for 24 hours in an oven at 60° C., to adjust thereby the water content of the polarizers to be not greater than 5 wt %. Thereafter, the protective layers of the intermediate constituent A and the intermediate constituent B were bonded to each other, at reduced pressure, via an adhesive layer 18 comprising a thermosetting epoxy resin (“EP582” by Cemedine Co., water vapor permeability 20 g/m²·24 hr), while the exposed portions of the polarizers 5, 6 were sealed at the same time with the adhesive layer 18, to yield a polarizing plate having the constitution illustrated in FIG. 3. An antireflection treatment comprising five dielectric layers formed by vacuum vapor deposition was applied to the outer faces, exposed to air, of the used sapphire substrate and quartz substrate.

The polarizing plate thus manufactured, having the constitution illustrated in FIG. 3, had a thickness of about 1.1 mm, which is thinner than the thickness of the polarizing plates in the below-described comparative examples, being thus appropriate for small optical systems in projection-type liquid crystal display devices or the like. The light resistance of the manufactured polarizing plate, was evaluated as in Example 1. The results are given in Table 1.

### Example 4

In Example 4 a polarizing plate having the constitution illustrated in FIG. 5 was manufactured as follows. As in Example 1, the intermediate constituent A and the intermediate constituent B were both dried for 24 hours in an oven at 60° C., to adjust thereby the water content of the polarizers to be not greater than 5 wt %. Thereafter, the intermediate constituent A and the intermediate constituent B were disposed sandwiching a 0.5 mm transparent substrate 2 (soda lime glass) in between, and were bonded at reduced pressure via adhesive layers 31, 32 comprising a thermosetting epoxy resin (“EP582” by Cemedine Co., water vapor permeability 20 g/m²·24 hr), while the exposed portions of the polarizers 5, 6 were sealed at the same time with the adhesive layers 31, 32, to prepare a polarizing plate having the constitution illustrated in FIG. 5. An antireflection treatment comprising five dielectric layers formed by vacuum vapor deposition was applied to the outer faces, exposed to air, of the transparent substrates 1, 3.

The polarizing plate thus manufactured, having the constitution illustrated in FIG. 5, had a thickness of about 1.6 mm, which is thinner than the thickness of the polarizing plates in the below-described comparative examples, being thus appropriate for small optical systems in projection-type liquid crystal display devices or the like. The light resistance of the manufactured polarizing plate, was evaluated as in Example 1. The results are given in Table 1.

### Example 5

In Example 5 a polarizing plate having the constitution illustrated in FIG. 6 was manufactured as follows. An intermediate constituent C was manufactured in accordance with the same manufacturing process of the intermediate constituent A of Example 1, except that herein the protective layer 7 formed on the polarizer 5 extended up to the side faces of the polarizer 5. Also, an intermediate constituent D was manufactured in accordance with the same manufacturing process of the intermediate constituent B, except that herein the protective layer 9 formed on the polarizer 6 extended up to the side faces of the polarizer 6, and the transparent substrate 3 bonded to the polarizer 6 was a quartz crystal substrate having a thickness of 0.5 mm.

The intermediate constituent C and the intermediate constituent D were both dried for 24 hours in an oven at 60° C., to adjust thereby the water content of the polarizers 5, 6 to be not greater than 5 wt %. Thereafter, the protective layer 7 of the intermediate constituent C and the protective layer 9 of the intermediate constituent D were disposed sandwiching a 0.5 mm transparent substrate 2 (soda lime glass) in between, and were bonded at reduced pressure via adhesive layers 33, 34 comprising a thermosetting epoxy resin (“EP582” by Cemedine Co., water vapor permeability 20 g/m²·24 hr), while the exposed portions of the polarizers 5, 6 were sealed at the same time with the adhesive layers 33, 34, to prepare a polarizing plate having the constitution illustrated in FIG. 6. An antireflection treatment comprising five dielectric layers formed by vacuum vapor deposition was applied to the outer faces, exposed to air, of the transparent substrates 1, 3.

The polarizing plate thus manufactured, having the constitution illustrated in FIG. 6 had a thickness of about 1.6 mm, which is thinner than the thickness of the polarizing plates in the below-described comparative examples, being thus appropriate for small optical systems in projection-type liquid crystal display devices or the like. The light resistance of the manufactured polarizing plate, was evaluated as in Example 1. The results are given in Table 1.

### Example 6

In Example 6 a polarizing plate having the constitution illustrated in FIG. 2 was manufactured as follows. On one face of a polarizer 5 manufactured in the same way as in Example 1 there was firstly bonded, under reduced pressure, a 0.5 mm-thick transparent substrate 1 (sapphire substrate, by Kyocera Corp.) via a 25 μm-thick adhesive layer 11 (the resulting build-up is referred hereafter as “intermediate constituent E”).

Similarly, on one face of the polarizer 6 there was bonded a 0.5 mm-thick transparent substrate 3 (spinel substrate) via a 5 μm-thick adhesive layer 12 comprising an acrylic UV-curable adhesive (“MO5” by Adell Corp.) (the resulting build-up is referred to hereinafter as “intermediate constituent F”). The intermediate constituent E and the intermediate constituent F were both dried for 24 hours in an oven at 80° C., to adjust thereby the water content of the polarizers 5, 6 to be not greater than 5 wt %. The polarizers 5, 6 of the intermediate constituent E and the intermediate constituent F were bonded to each other, under reduced pressure, via an adhesive layer 13. Thereafter, the exposed portions of the polarizers 5, 6 were sealed by applying the sealing agent 16, comprising a thermosetting epoxy resin (“TB3025G” by Three Bond Co., Ltd., water vapor permeability 10 g/m²·24 hr), on the exposed portions of the polarizers 5, 6, followed by curing. An antireflection treatment comprising five dielectric layers formed by vacuum vapor deposition was applied to the outer faces, exposed to air, of the transparent substrates 1, 3.

The polarizing plate thus obtained, having the constitution illustrated in FIG. 2, was evaluated as in Example 1. The results are given in Table 1.

### Examples 7 to 10

Polarizing plates were manufactured in the same way as in Example 6, using the transparent substrate 1, transparent substrate 2 and transparent substrate 3 given in Table 1, and drying herein the polarizers 5, 6 under the drying conditions set forth in Table 1. The manufactured polarizing plates were evaluated in the same way as in Example 1. The results are given in Table 1.

### Comparative Example 1

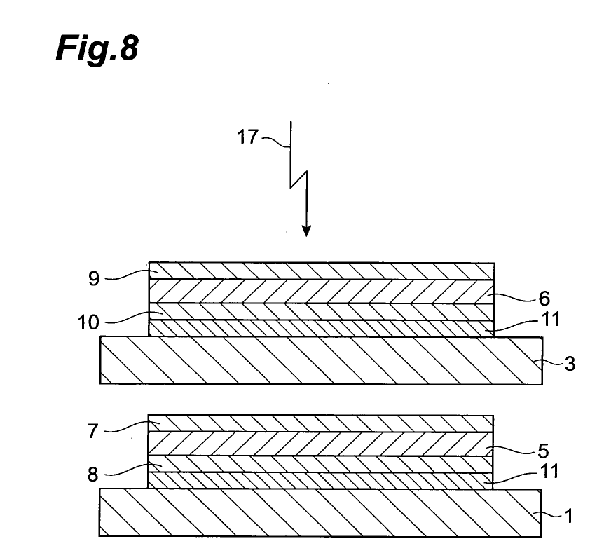

In Comparative example 1 there was manufactured a polarizing plate having the constitution illustrated in FIG. 8. On both faces of polarizers 5, 6 obtained in the same way as in Example 1 there were bonded first 80 μm-thick acetyl cellulose films (“KC8UY” by Konica Corp., hereafter 8UYTAC), as protective layers 7, 8, 9, 10, via adhesives having as active constituents thereof a carboxyl-modified polyvinyl alcohol resin (product name “KL318”) and a water-soluble polyamide epoxy resin (product name “Sumirez Resin 650”), to manufacture thereby two polarizing films.

A 0.5 mm-thick transparent substrate 1 (sapphire substrate, by Kyocera Corp.) was bonded via an adhesive layer 11 to one face of the polarizing film having the polarizer 5, to yield a first polarizing plate. A 0.5 mm-thick transparent substrate 3 (quartz crystal substrate) was bonded via an adhesive layer 11 to one face of the polarizing film having the polarizer 6, to yield a second polarizing plate.

These two polarizing plates were disposed relative to the direction of light incidence as illustrated in FIG. 8. The two polarizing plates were arranged with a spacing of 5 mm in between, to avoid temperature rises. The overall thickness, including the spacing between the polarizing plates, was of about 6.4 mm.

The polarizing plates thus manufactured, having the constitution illustrated in FIG. 8, were evaluated in the same way as that of Example 1. The results are given in Table 1.

### Comparative Example 2

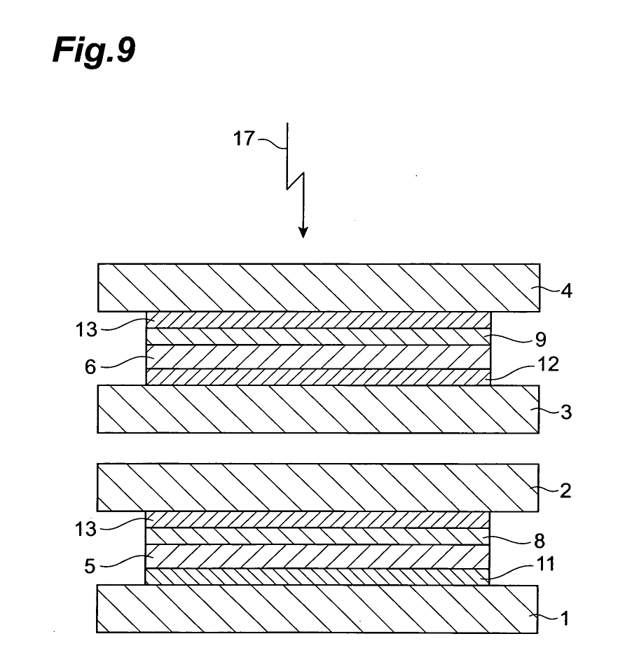

In Comparative example 2 there was manufactured a polarizing plate having the constitution illustrated in FIG. 9. Firstly, an intermediate constituent A and an intermediate constituent B manufactured in the same way as in Example 1, without further modification, were dried for 24 hours in an oven at 60° C., to adjust the water content of the polarizers 5, 6 not greater than 5 wt %. Thereafter, a transparent substrate 2 and a protective layer 8 of the intermediate constituent A, and a transparent substrate 4 and a protective layer 9 of the intermediate constituent B were respectively bonded, under reduced pressure, via adhesive layers 13 comprising an acrylic UV-curable adhesive (“MO5” by Adell Corp.), to yield two polarizing plates. An antireflection treatment comprising five dielectric layers formed by vacuum vapor deposition was applied to the outer faces, exposed to air, of the transparent substrates 1, 2, 3 and 4.

These two polarizing plates were disposed relative to the direction of light incidence as illustrated in FIG. 9. The two polarizing plates were arranged with a spacing of 5 mm in between to avoid temperature rises. The overall thickness, including the spacing between the polarizing plates, was of about 7.1 mm.

The polarizing plates thus manufactured, having the constitution illustrated in FIG. 9, were evaluated in the same way as that of Example 1. The results are given in Table 1.

TABLE 1

| | | | | | | | Light | | |
|---|---|---|---|---|---|---|---|---|---|
| | Build-up | | | | | | resistance | | |
| | Protective | Transparent | Transparent | Transparent | Drying | | | Long- | Size |
| | layer | substrate 1 | substrate 2 | substrate 3 | conditions | Sealing | Initial | term | reduction |
| Ex. 1 | 10 mm | Sapphire | None | Soda lime | 70° C. | FIG. 1 | ◯ | ◯ | ◯ |
| | UV-curable | | | glass | 10 hr | | | | |
| | resin | | | | | | | | |
| Ex. 2 | 10 mm | Sapphire | Soda lime | Soda lime | 70° C. | FIG. 4 | ◯ | ◯ | ◯ |
| | UV-curable | | glass | glass | 10 hr | | | | |
| | resin | | | | | | | | |
| Ex. 3 | 10 mm | Sapphire | None | Quartz | 60° C. | FIG. 3 | ◯ | ◯ | ◯ |
| | UV-curable | | | | 24 hr | | | | |
| | resin | | | | | | | | |
| Ex. 4 | 10 mm | Sapphire | Soda lime | Quartz | 60° C. | FIG. 5 | ◯ | ◯ | ◯ |
| | UV-curable | | glass | | 24 hr | | | | |
| | resin | | | | | | | | |
| Ex. 5 | 10 mm | Sapphire | Soda lime | Quartz | 60° C. | FIG. 6 | ◯ | ◯ | ◯ |
| | UV-curable | | glass | | 24 hr | | | | |
| | resin | | | | | | | | |
| Ex. 6 | None | Sapphire | None | Spinel | 80° C. | FIG. 2 | ◯ | ◯ | ◯ |
| | | | | | 24 hr | | | | |
| Ex. 7 | None | Spinel | None | Spinel | 80° C. | FIG. 2 | ◯ | ◯ | ◯ |
| | | | | | 24 hr | | | | |
| Ex. 8 | None | Spinel | None | Quartz | 80° C. | FIG. 2 | ◯ | ◯ | ◯ |
| | | | | | 24 hr | | | | |
| Ex. 9 | None | Spinel | None | Soda lime | 80° C. | FIG. 2 | ◯ | ◯ | ◯ |
| | | | | glass | 24 hr | | | | |
| Ex. | None | Quartz | None | Soda lime | 80° C. | FIG. 2 | ◯ | ◯ | ◯ |
| 10 | | | | glass | 24 hr | | | | |
| Com. | 80 mm | Sapphire | None | Quartz | None | FIG. 7 | X | X | X |
| Ex. 1 | TAC | | | | | | | | |
| Com. | 10 mm | Sapphire | Quartz | None | 60° C. | FIG. 8 | ◯ | ◯ | X |
| Ex. 2 | UV-curable | | | | 24 hr | | | | |
| | resin | | | | | | | | |

* Ex.: Example, Com. Ex.: Compressive Example
In “light resistance” in the table, ◯ denotes no light leakage for 250 hrs since the evaluation for the light resistance started, and × denotes light leakage for 250 hrs since the evaluation for the light resistance started.

What is claimed is:

1. A polarizing plate comprising at least two transparent substrates spaced apart and facing one another, and at least two polarizers provided between an outermost-positioned first transparent substrate and another outermost-positioned second transparent substrate,
wherein all the polarizers are sealed so as not to be in contact with outer air.

2. The polarizing plate according to claim 1, wherein adhesive layers are respectively formed on mutually opposing inner faces of the first transparent substrate and the second transparent substrate, the polarizers being respectively attached to the transparent substrates via the adhesive layers.

3. The polarizing plate according to claim 2, wherein a transmittance in an absorption axis direction of one of the polarizers respectively attached to the first transparent substrate and the second transparent substrate is 10% to 70%, while the transmittance in the absorption axis direction of the other polarizer is not greater than 1%, for light having a central wavelength of 440 nm.

4. The polarizing plate according to claim 2, wherein a transmittance in an absorption axis direction of one of the polarizers respectively attached to the first transparent substrate and the second transparent substrate is 10% to 70%, while the transmittance in the absorption axis direction of the other polarizer is not greater than 1%, for light having a central wavelength of 550 nm.

5. The polarizing plate according to claim 2, wherein a transmittance in an absorption axis direction of one of the polarizers respectively attached to the first transparent substrate and the second transparent substrate is 10% to 70%, while the transmittance in the absorption axis direction of the other polarizer is not greater than 1%, for light having a central wavelength of 610 nm.

6. The polarizing plate according to claim 2, wherein a face of the polarizer attached to the first transparent substrate, opposite the face at which the polarizer is in contact with the adhesive layer, and a face of the polarizer attached to the second transparent substrate, opposite the face at which the polarizer is in contact with the adhesive layer, are bonded via an adhesive layer.

7. The polarizing plate according to claim 2, wherein respective protective layers are formed on faces of the polarizers respectively attached to the first transparent substrate and the second transparent substrate opposite the faces in contact with the adhesive layers.

8. The polarizing plate according to claim 7, wherein the protective layer formed on the polarizer attached to the first transparent substrate, and the protective layer formed on the polarizer attached to the second transparent substrate, are bonded via an adhesive layer.

9. The polarizing plate according to claim 7, wherein the protective layer formed on the polarizer attached to the first transparent substrate, and the protective layer formed on the polarizer attached to the second transparent substrate, are bonded via adhesive layers sandwiching a third transparent substrate.

10. The polarizing plate according to claim 7, wherein the protective layers comprise a cured curable resin, and a thickness thereof is 0.1 μm to 30 μm.

11. The polarizing plate according to claim 7, wherein a main constituent of the protective layers is triacetyl cellulose or an olefin resin, and a thickness thereof is 5 μm to 50 μm.

12. The polarizing plate according to claim 2, wherein exposed portions, not in contact with the adhesive layers, of the polarizers respectively attached to the first transparent substrate and the second transparent substrate, are sealed by a sealing agent.

13. The polarizing plate according to claim 7, wherein exposed portions, not in contact with the adhesive layers, and not in contact with the protective layers, of the polarizers respectively attached to the first transparent substrate and the second transparent substrate, are sealed by a sealing agent.

14. The polarizing plate according to claim 12, wherein the sealing agent is a resin having a water vapor permeability not greater than 60 g/m²·24 hr.

15. The polarizing plate according to claim 12, wherein the sealing agent has a boiling water absorption ratio not greater than 4 wt %.

16. The polarizing plate according to claim 12, wherein the sealing agent is the same material as the adhesive layers.

17. The polarizing plate according to claim 13, wherein the sealing agent is the same material as the protective layers.

18. The polarizing plate according to claim 1, wherein at least one among the first transparent substrate and the second transparent substrate has a thermal conductivity not lower than 5 W/(m·K).

19. The polarizing plate according to claim 1, wherein at least one among the first transparent substrate and the second transparent substrate has a front retardation smaller than 5 nm in the 380 nm to 780 nm wavelength range.

20. The polarizing plate according to claim 1, wherein the water content of the polarizers is not greater than 5 wt %.

21. An optical member, comprising the polarizing plate according to claim 1, and a retardation film bonded thereto.

22. A polarizing plate manufacturing method, comprising the step of:
disposing at least two transparent substrates spaced apart and facing one another, forming respective adhesive layers on mutually opposing inner faces of an outermost-positioned first transparent substrate and another outermost-positioned second transparent substrate, and attaching respective polarizers onto the first transparent substrate and the second transparent substrate via the adhesive layers,
wherein bonding of the transparent substrates and the polarizers via the adhesive layers is carried out under reduced pressure.

23. The polarizing plate manufacturing method according to claim 22, further comprising the step of drying the polarizers bonded to the transparent substrates at a temperature not higher than 130° C.

24. A projection-type liquid crystal display device, comprising the polarizing plate according to claim 1.
